(19) United States
(12) Patent Application Publication
(10) Pub. No.: US 2013/0305328 A1
(43) Pub. Date: Nov. 14, 2013

(54) SYSTEMS AND METHODS FOR PASSING PASSWORD INFORMATION BETWEEN USERS

(71) Applicant: Wai Pong Andrew LEUNG, Hong Kong (HK)

(72) Inventor: Wai Pong Andrew LEUNG, Hong Kong (HK)

(21) Appl. No.: 13/466,738

(22) Filed: May 8, 2012

(51) Int. Cl. G06F 21/00

(52) U.S. Cl. 726/6

(57) ABSTRACT

Systems and methods are provided for sharing passwords from one user to another. In one embodiment, a system is provided. The system generates a password based on the phone number, resource, and an encryption method. The system then generates an encrypted resource, based on the email address, phone number, file, and the encryption method. The encrypted resource may then be decrypted using the password received from the second user, after successfully identifying the second user and the file, and allowing the second user to access the file using the web page.

### FIELD OF THE INVENTION

This invention generally relates to techniques sharing secured information. Specifically, but not related to, this invention allows users to share password-related information with third parties.

### BACKGROUND OF THE INVENTION

Most modern security systems encourage users to keep their passwords safely and discourage the users to share such information to others. Even used in a corporate environment, organizational users are often prohibited to share any password-related information to any other users. When a user loses his or her password, the user is required to submit a request to administrators for resending a new password. The old password would immediately be voided and the user would be granted a new password. Such rigid use of passwords can be regarded as inflexible. But to many, the high level protection is often needed given the importance of the underlying assets being protected. For some resources or assets of which lower priority of protection should be afforded, there is a greater need to be flexible in password management. For example, the resource or asset may be a spreadsheet file that has a lower priority of importance, or the resource or asset is a password used to access a door that has only a secondary priority. In such cases, an invention allows sharing of password-related information is highly desirable.

### SUMMARY OF THE INVENTION

According to embodiments of the present invention, a system for passing password information between users is provided. The system may comprise a web page, a processor, and a memory storing instructions configured to be executed by the processor to implement a computer-implemented method. In one embodiment, the exemplary method comprises receiving an email address from a first user. The email address may be associated with a second user. After receiving the email address from the first user, a user account may be created for the second user based on the email address, wherein the user account is used to access the web page. Further in the embodiment, a phone number may also be received from the first user, wherein the phone number can be associated with the second user. Additionally, among the information received from the first user, a resource, such as a file associated with the second user, may be provided. After the information is received, a password would be generated based on the received phone number, resource, and an encryption method. Further, an encrypted resource would be generated based on the email address, phone number, resource, and the encryption method. Thereafter, an email message may be sent to the second user, wherein the email message includes instructions to access the encrypted resource using the password. A text message would then be sent by using the phone number to the second user to notify the second user that an email message relating to password management has been sent by the first user to the second user, wherein the text message includes the password and the instructions to access the encrypted resource using the password. As an identification process, when receiving the email address and the password from the second user using the web page, the identification process identifies the second user based on the email address and identifies the encrypted resource based on the password. The identification process further decrypts the encrypted resource using the password received from the second user, after successfully identifying the second user and the file, before allowing the second user to access the resource using the web page.

In the present invention, a web page is used as a platform to host resources that can be accessible by authorized users. In other embodiments, other platforms may be used, including a server, a computer, or a database. Similarly, communications modes in this invention are not limited to email access and phone communications. Other modes of communications are be used in this invention. In one embodiment, chatroom communications, instant messages, and other forms of online communications may also be used. Accordingly, identifiers used in the respective forms of communications are not limited to email addresses or phone numbers but can be open to other labels or identifiers as long as the users can be uniquely identified.

In an alternative embodiment, the second user is allowed to share access of the encrypted file, so that an email address associated with a third user can be received from the second user using the web page. Further in the embodiment, a user account can be created for the third user based on the email address associated with the third user, wherein the user account for the third user is used to access the web page. In creating the third user, a phone number associated with the third user may be received from the second user. Thereafter, a password associated with the third user can be generated based on the phone number associated with the third user, file, and encryption method, and an email message associated with the third user can be sent to the third user, wherein the email message associated with the third user includes instructions to access the encrypted resource using the password associated with the third user. A text message using the phone number may be sent to the third user to notify the third user that an email message relating to password management has been sent by the second user to the third user, wherein the text message associated with the third user includes the password associated with the third user and the instructions to access the encrypted file using the password.

As an identification process, an email address associated with the third user and the password associated with the third user may be received from the third user using the web page, wherein the identification process identifies the third user based on the email address associated with the third user and identifies the encrypted file based on the password associated with the third user. The encrypted file may then be decrypted using the password received from the third user, after successfully identifying the third user and the encrypted file and allowing the third user to access the file using the web page.

In another embodiment of the present invention, a checking mechanism can be provided. After receiving the email address from the second user, the email address can be checked whether the email address is found in a denied access list. The third user may be denied from accessing the encrypted file after finding the email address associated with the third user in the denied access list. If necessary, a second email message and a second text message may be sent to the second user to notify the denying of the third user from accessing the encrypted file.

In yet another embodiment, after successfully identifying the third user and the encrypted file, decryption can be done to decrypt the encrypted file using the password received from the third user. At this point, a second copy of the file can be generated to allow the third user to access second copy of the file.

An additional feature can include allowing the first user to place an instruction before sharing a password. In this feature, the first user can be used to set an expiry time period, so that the second user can be denied from accessing the encrypted file, after finding the password has been expired.

### BRIEF DESCRIPTION OF THE DRAWINGS

FIG. 1 illustrates a block diagram of a password sharing system, consistent with an embodiment of the present invention.

FIG. 2 illustrates a flow diagram of a password sharing system allowing a user to securely generate a password for a video.

### DETAILED DESCRIPTION

This invention relates to a system for passing password information between users. There are multiple uses of this invention. One use is a system for passing password information between users through the internet web sites and mobile phones. As an example, the exemplary system includes a web page; a processor; a memory storing instructions configured to be executed by the processor to implement a computer-implemented method. The method comprises receiving an email address from a first user, wherein the email address is associated with a second user; creating a user account for the second user based on the email address, wherein the user account is used to access the web page; receiving a phone number from the first user, wherein the phone number is associated with the second user; receiving a file from the first user, wherein the file is associated with the second user; generating a password, based on the phone number, file, and an encryption method; generating a encrypted resource, based on the email address, phone number, file, and the encryption method; sending an email message to the second user, wherein the email message includes instructions to access the encrypted resource using the password; sending a text message, using the phone number, to the second user to notify the second user that an email message relating to password management has been sent by the first user to the second user, wherein the text message includes the password and the instructions to access the encrypted file using the password; as an identification process, receiving the email address and the password from the second user using the web page, wherein the identification process identifies the second user based on the email address and identifies the encrypted file based on the password; decrypting the encrypted file using the password received from the second user, after successfully identifying the second user and the file; and allowing the second user to access the file using the web page.

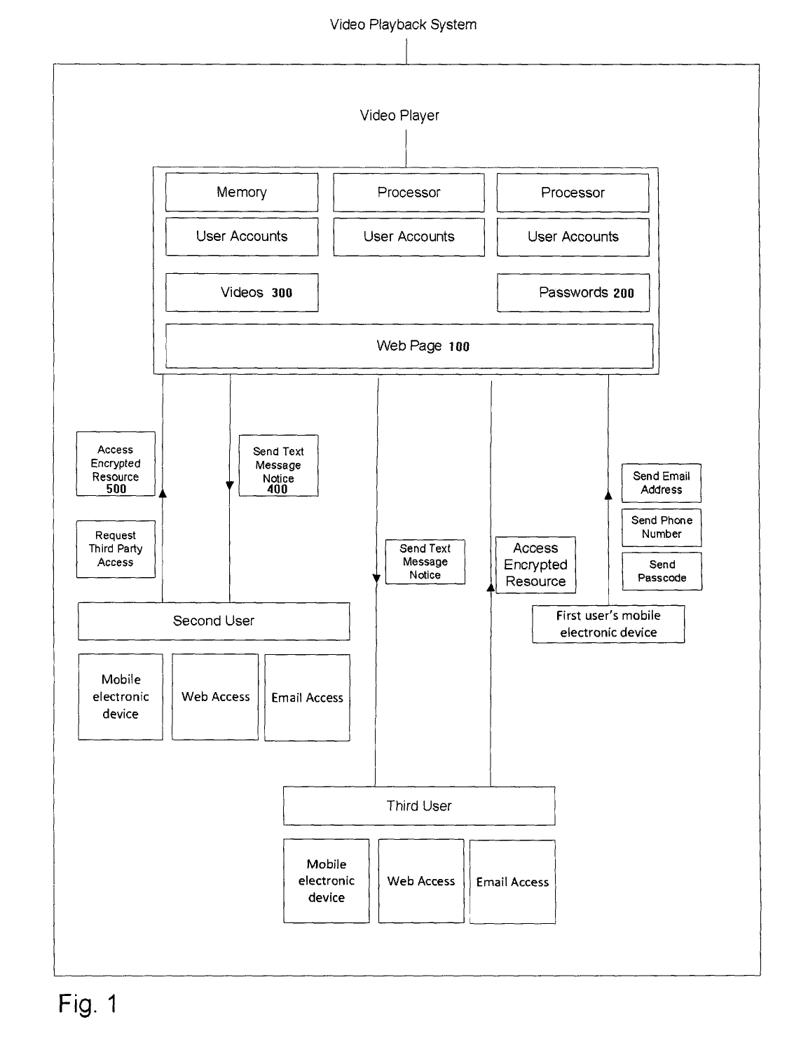

Now referring to FIG. 1 for another use of the present invention, a secured video playback system for passing passwords between users is provided. The video playback system includes a video player, wherein videos played by the player are password enabled and being connecting to a network. The system allow includes a web page (100), a processor, a first mobile electronic device, a second mobile electronic device, a third mobile electronic device; and a memory storing instructions configured to be executed by the processor to implement a computer-implemented method. The method comprises: receiving an email address from a first user using the first mobile electronic device, wherein the email address is associated with a second user; creating a user account for the second user based on the email address, wherein the user account is used to access the web page (100); receiving a phone number from the first user, wherein the phone number is associated with the second user; receiving a passcode from the first user, wherein the passcode is associated with accessing a video (300) stored in the video player; generating a password (200), based on the phone number, passcode, and an encryption method; generating an encrypted resource, based on the email address, phone number, passcode, and the encryption method; sending an email message to the second user, wherein the email message includes instructions to access the encrypted resource using the password (200); sending a text message (400) to the second mobile electronic device, using the phone number, to the second user to notify the second user that an email message relating to password management has been sent by the first user to the second user, wherein the text message includes the password (200) and the instructions to access the encrypted resource (500) using the password (200); as an identification process, receiving the email address and the password (200) from the second user through the web page (100), wherein the identification process identifies the second user based on the email address and identifies the encrypted resource based on the password; decrypting the encrypted resource using the password (200) received from the second user, after successfully identifying the second user and the resource; allowing the second user to access the video (300) using the decrypted resource; to allow the second user to share access of the video, receiving an email address from the second user using the web page (100), wherein the email address is associated with a third user that is connected to the third mobile electronic device; after receiving the email address from the second user, checking if the email address is found in a denied access list; denying the third user from accessing the encrypted resource, after finding the email address associated with the third user in the denied access list; and sending a second email message and a second text message to the second user to notify the denying of the third user from accessing the video.

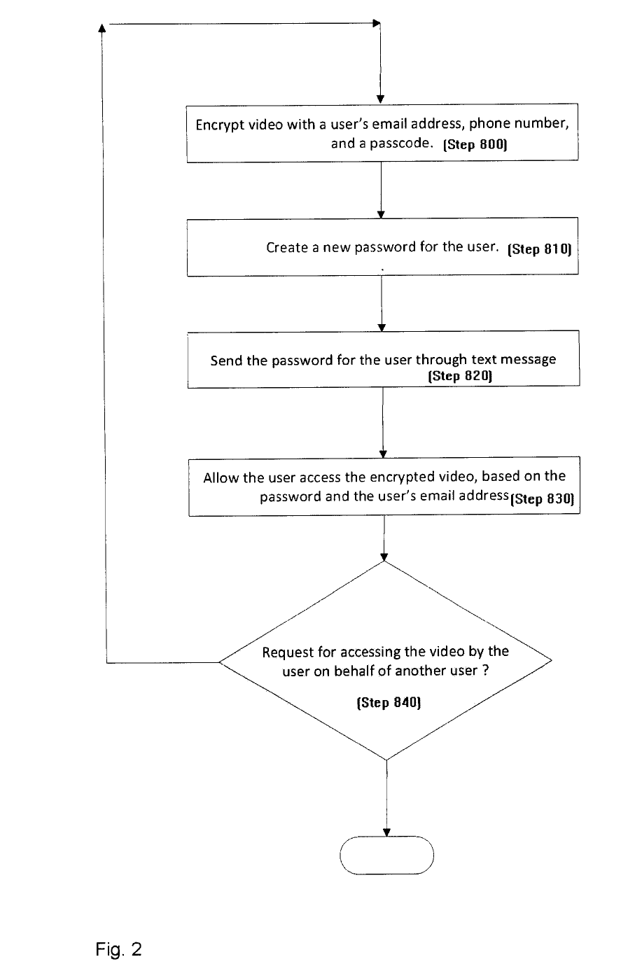

FIG. 2 refers to a flow diagram to show how an exemplary video system can be shared to a user based on the password management system of the present invention. The system of the present invention can encrypt the video with the first user's email address, phone number, and a passcode (step 800). Further, a password can be created for the user (step 810), so that the password can be sent to the user via a text message (step 820). After that, the user can access the encrypted video, based on the password and the user's email address. At this point, if desirable the user can request the system to grant access on behalf another user (step 840).

Other uses can be made available through this invention. One use is a security system for passing password information between users. The system can include a car that is password enabled and being connecting to a network; a first mobile device; a second mobile device; a third mobile device; a web page; a processor; and a memory storing instructions configured to be executed by the processor to implement a computer-implemented method. The method comprising receiving an email address from a first user, wherein the email address is associated with a second user; creating a user account for the second user based on the email address, wherein the user account is used to access the web page; receiving a phone number from the first user using the first mobile device, wherein the phone number is associated with the second user; receiving a file from the first user, wherein the file is associated with the second user and used to access the car; generating a password, based on the phone number, file, and an encryption method; generating a encrypted resource, based on the email address, phone number, file, and the encryption method; sending an email message to the second user, wherein the email message includes instructions to access the encrypted resource using the password; sending a text message, using the phone number, to the second user through the second mobile device to notify the second user that an email message relating to password management has been sent by the first user to the second user, wherein the text message includes the password and the instructions to access the encrypted file using the password; as an identification process, receiving the email address and the password from the second user through the web page, wherein the identification process identifies the second user based on the email address and identifies the encrypted file based on the password; decrypting the encrypted file using the password received from the second user, after successfully identifying the second user and the resource; allowing the second user to access the file; to allow the second user to share access of the encrypted file, receiving an email address from the second user using the web page, wherein the email address is associated with a third user; creating a user account for the third user based on the email address associated with the third user using the third mobile device, wherein the user account for the third user is used to access the web page; receiving a phone number from the second user, wherein the phone number is associated with the third user; generating a password associated with the third user, based on the phone number associated with the third user, file, and encryption method; sending an email message associated with the third user to the third user, wherein the email message associated with the third user includes instructions to access the encrypted resource using the password associated with the third user; sending a text message associated with the third user, using the phone number, to the third user to notify the third user that an email message relating to password management has been sent by the second user to the third user, wherein the text message associated with the third user includes the password associated with the third user and the instructions to access the encrypted file using the password; as an identification process, receiving the email address associated with the third user and the password associated with the third user from the third user using the web page, wherein the identification process identifies the third user based on the email address associated with the third user and identifies the encrypted file based on the password associated with the third user; decrypting the encrypted file using the password received from the third user, after successfully identifying the third user and the encrypted file; and allowing the third user to access the file using the web page.

In yet another use of this invention, a door that is password enabled and being connecting to a network is provided. The exemplary door has a web page; a processor; and a memory storing instructions configured to be executed by the processor to implement a computer-implemented method. The method comprises: receiving an email address from a first user, wherein the email address is associated with a second user; creating a user account for the second user based on the email address, wherein the user account is used to access the web page; receiving a phone number from the first user, wherein the phone number is associated with the second user; receiving a file from the first user, wherein the file is associated with the second user and used to access the door; generating a password, based on the phone number, file, and an encryption method; generating a encrypted resource, based on the email address, phone number, file, and the encryption method; sending an email message to the second user, wherein the email message includes instructions to access the encrypted resource using the password; sending a text message, using the phone number, to the second user to notify the second user that an email message relating to password management has been sent by the first user to the second user, wherein the text message includes the password and the instructions to access the encrypted file using the password; as an identification process, receiving the email address and the password from the second user through the web page, wherein the identification process identifies the second user based on the email address and identifies the encrypted file based on the password; decrypting the encrypted file using the password received from the second user, after successfully identifying the second user and the resource; allowing the second user to write the file; to allow the second user to share access of the encrypted file, receiving an email address from the second user using the web page, wherein the email address is associated with a third user; creating a user account for the third user based on the email address associated with the third user, wherein the user account for the third user is used to access the web page; receiving a phone number from the second user, wherein the phone number is associated with the third user; generating a password associated with the third user, based on the phone number associated with the third user, file, and encryption method; sending an email message associated with the third user to the third user, wherein the email message associated with the third user includes instructions to access the encrypted resource using the password associated with the third user; sending a text message associated with the third user, using the phone number, to the third user to notify the third user that an email message relating to password management has been sent by the second user to the third user, wherein the text message associated with the third user includes the password associated with the third user and the instructions to access the encrypted file using the password; as an identification process, receiving the email address associated with the third user and the password associated with the third user from the third user using the web page, wherein the identification process identifies the third user based on the email address associated with the third user and identifies the encrypted file based on the password associated with the third user; decrypting the encrypted file using the password received from the third user, after successfully identifying the third user and the encrypted file; and allowing the third user to access the file, after the second user completes writing the file.

What is claimed is:

1. A system for passing password information between users safely and yet efficiently, wherein the users can dynamically grant un-registered users access to resources that would be encrypted or password-protected based on a plurality of identifiers of the un-registered users provided by the users, comprising:
a web page;
a processor;
a memory storing instructions configured to be executed by the processor to implement a computer-implemented method, the method comprising:
receiving an email address from a first user who has authority to grant the un-registered users access to a resource, wherein the email address is associated with a second user;
creating a user account for the second user based on the email address, wherein the user account is used to access the web page;
receiving a phone number from the first user, wherein the phone number is associated with the second user;
generating an access token, based on the phone number, the resource, and an encryption method;
generating an encrypted resource, based on the email address, the phone number, the resource, and the encryption method, wherein the encrypted resource would be accessible by only the second user using the access token that is generated specifically for the second user;
sending an email message to the second user, wherein the email message includes instructions to access the encrypted resource using the access token;
sending a text message, using the phone number, to the second user to notify the second user that an email message relating to password management has been sent by the first user to the second user, wherein the text message includes the access token and the instructions to access the encrypted resource using the access token;
as an identification process, receiving the email address and the access token from the second user using the web page, wherein the identification process identifies the second user based on the email address and identifies the encrypted resource based on the access token;
decrypting the encrypted resource to retrieve the resource using the access token received from the second user, after successfully identifying the second user and the encrypted resource; and
allowing the second user to access the resource using the web page.

2. The system of claim 1, wherein the method further comprises:
allowing the second user, who was one of the un-registered users, to share access of the encrypted resource by requesting an email address from the second user using the web page, wherein the email address is associated with a third user who is one of the unregistered users;
creating a user account for the third user based on the email address associated with the third user, wherein the user account for the third user is used to access the web page;
receiving a phone number from the second user, wherein the phone number is associated with the third user;
generating an access token associated with the third user, based on the phone number associated with the third user, the encrypted resource, and the encryption method;
sending an email message associated with the third user to the third user, wherein the email message associated with the third user includes instructions to access the encrypted resource using the access token associated with the third user;
sending a text message associated with the third user, using the phone number, to the third user to notify the third user that an email message relating to password management has been sent by the second user to the third user, wherein the text message associated with the third user includes the access token associated with the third user and the instructions to access the encrypted resource using the access token;
as an identification process, receiving the email address associated with the third user and the access token associated with the third user from the third user using the web page, wherein the identification process identifies the third user based on the email address associated with the third user and identifies the encrypted resource based on the access token associated with the third user;
decrypting the encrypted resource to retrieve the resource using the access token received from the third user, after successfully identifying the third user and the encrypted resource; and
allowing the third user to access the resource using the web page.

3. The system of claim 1, wherein the method further comprises:
allowing the second user to share access of the encrypted resource;
receiving an email address from the second user using the web page, wherein the email address is associated with a third user;
after receiving the email address from the second user, checking if the email address is found in a denied access list;
denying the third user from accessing the encrypted resource, after finding the email address associated with the third user in the denied access list; and
sending a second email message and a second text message to the second user to notify the denying of the third user from accessing the encrypted resource.

4. The system of claim 1, wherein the method further comprises:
allowing the second user to share access of the encrypted resource, receiving an email address from the second user using the web page, wherein the email address is associated with a third user;
creating a user account for the third user based on the email address associated with the third user, wherein the user account for the third user is used to access the web page;
receiving a phone number from the second user, wherein the phone number is associated with the third user;
receiving information relating to an access right from the second user, wherein the access right is associated with granting the third user read access to the encrypted resource;
generating an access token associated with the third user, based on the phone number associated with the third user, encrypted resource, and encryption method;
sending an email message associated with the third user to the third user, wherein the email message associated with the third user includes instructions to access the encrypted resource using the access token associated with the third user;
sending a text message associated with the third user, using the phone number, to the third user to notify the third user that an email message relating to password management has been sent by the second user to the third user, wherein the text message associated with the third user includes the access token associated with the third user and the instructions to access the encrypted resource using the access token;
as an identification process, receiving the email address associated with the third user and the access token associated with the third user from the third user using the web page, wherein the identification process identifies the third user based on the email address associated with the third user and identifies the encrypted resource based on the access token associated with the third user;
decrypting the encrypted resource to retrieve the resource using the access token received from the third user, after successfully identifying the third user and the encrypted resource; and
allowing the third user to retrieve the resource using the web page.

5. The system of claim 1, wherein the method further comprises:
allowing the second user to share access of the encrypted resource, receiving an email address from the second user using the web page, wherein the email address is associated with a third user;
creating a user account for the third user based on the email address associated with the third user, wherein the user account for the third user is used to access the web page;
receiving a phone number from the second user, wherein the phone number is associated with the third user;
generating an access token associated with the third user, based on the phone number associated with the third user, encrypted resource, and encryption method;
sending an email message associated with the third user to the third user, wherein the email message associated with the third user includes instructions to access the encrypted resource using the access token associated with the third user;
sending a text message associated with the third user, using the phone number, to the third user to notify the third user that an email message relating to password management has been sent by the second user to the third user, wherein the text message associated with the third user includes the access token associated with the third user and the instructions to access the encrypted resource using the access token;
as an identification process, receiving the email address associated with the third user and the access token associated with the third user from the third user using the web page, wherein the identification process identifies the third user based on the email address associated with the third user and identifies the encrypted resource based on the access token associated with the third user;
decrypting the encrypted resource to retrieve the resource using the access token received from the third user, after successfully identifying the third user and the encrypted resource;
generating a second copy of the resource; and
allowing the third user to access second copy of the resource.

6. The system of claim 1, wherein the method further comprises:
allowing the second user to share access of the encrypted resource, receiving an email address from the second user using the web page, wherein the email address is associated with a third user;
creating a user account for the third user based on the email address associated with the third user, wherein the user account for the third user is used to access the web page;
receiving a phone number from the second user, wherein the phone number is associated with the third user;
generating an access token associated with the third user, based on the phone number associated with the third user, encrypted resource, and encryption method;
sending an email message associated with the third user to the third user, wherein the email message associated with the third user includes instructions to access the encrypted resource using the access token associated with the third user;
sending a text message associated with the third user, using the phone number, to the third user to notify the third user that an email message relating to password management has been sent by the second user to the third user, wherein the text message associated with the third user includes the access token associated with the third user and the instructions to access the encrypted resource using the access token;
as an identification process, receiving the email address associated with the third user and the access token associated with the third user from the third user using the web page, wherein the identification process identifies the third user based on the email address associated with the third user and identifies the encrypted resource based on the access token associated with the third user;
decrypting the encrypted resource to retrieve the resource using the access token received from the third user, after successfully identifying the third user and the encrypted resource; and
allowing the third user to access the resource, after the second user completes writing the resource.

7. The system of claim 1, wherein the method further comprises:
generating a second encrypted resource, based on the email address, phone number, second resource, and the encryption method;
sending a first email message to the second user, wherein the first email message includes instructions to access the first encrypted resource using the first access token;
sending a second email message to the second user, wherein the second email message includes instructions to access the second encrypted resource using the second access token;
sending a first text message, using the phone number, to the second user to notify the second user that a first email message relating to password management has been sent by the first user to the second user, wherein the text message includes the first access token and the instructions to access the first encrypted resource using the first access token;
sending a second text message, using the phone number, to the second user to notify the second user that a second email message relating to password management has been sent by the first user to the second user, wherein the second text message includes the second access token and the instructions to access the second encrypted resource using the second access token;
as an identification process, receiving the email address from the second user using the web page to identify the second user based on the first email message;
as the identification process, receiving the first access token from the second user to identify the first encrypted resource;
as the identification process, receiving the second access token from the second user to identify the second encrypted resource;
decrypting the first encrypted resource to retrieve the first resource using the first access token received from the second user;
decrypting the second encrypted resource to retrieve the second resource using the second access token received from the second user; and
allowing the second user to access the first and second resource using the web page.

8. The system of claim 1, wherein the method further comprises:
allowing the second user to write the resource;
recording logging information with respect to writing the resource by the second user;
allowing the second user to share access of the encrypted resource, receiving an email address from the second user using the web page, wherein the email address is associated with a third user;
creating a user account for the third user based on the email address associated with the third user, wherein the user account for the third user is used to access the web page;
receiving a phone number from the second user, wherein the phone number is associated with the third user;
receiving information relating to an access right from the second user, wherein the access right is associated with granting the third user read access to the encrypted resource;
generating an access token associated with the third user, based on the phone number associated with the third user, encrypted resource, and encryption method;
sending an email message associated with the third user to the third user, wherein the email message associated with the third user includes instructions to access the encrypted resource using the access token associated with the third user;
sending a text message associated with the third user, using the phone number, to the third user to notify the third user that an email message relating to password management has been sent by the second user to the third user, wherein the text message associated with the third user includes the access token associated with the third user and the instructions to access the encrypted resource using the access token;
as an identification process, receiving the email address associated with the third user and the access token associated with the third user from the third user using the web page, wherein the identification process identifies the third user based on the email address associated with the third user and identifies the encrypted resource based on the access token associated with the third user;
decrypting the encrypted resource to retrieve the resource using the access token received from the third user, after successfully identifying the third user and the encrypted resource;
allowing the third user to retrieve the resource using the web page; and
recording logging information with respect to retrieval of the resource by the third user.

9. The system of claim 1, wherein the method further comprises:
receiving an instruction from the first user, wherein the instruction relates to an expiry time period;
creating a user account for the second user based on the email address, wherein the user account is used to access the web page;
receiving a phone number from the first user, wherein the phone number is associated with the second user;
receiving a resource from the first user, wherein the resource is associated with the second user;
generating an access token, based on the phone number, resource, and an encryption method;
generating a encrypted resource, based on the email address, phone number, resource, and the encryption method;
sending an email message to the second user, wherein the email message includes instructions to access the encrypted resource using the access token;
sending a text message, using the phone number, to the second user to notify the second user that an email message relating to password management has been sent by the first user to the second user, wherein the text message includes the access token and the instructions to access the encrypted resource using the access token;
as an identification process, receiving the email address and the access token from the second user using the web page, wherein the identification process identifies the second user based on the email address and identifies the encrypted resource based on the access token;
confirming if the access token is expired, in accordance with the expiry time period; and
denying the second user from accessing the encrypted resource, after finding the access token has been expired.

10. A security system for passing password information between users, comprising:
a car that is GPS enabled, password protected and being connecting to a network;
a first mobile device;
a second mobile device;
a third mobile device;
a web page;
a processor;
a memory storing instructions configured to be executed by the processor to implement a computer-implemented method, the method comprising:
receiving an email address from a first user, wherein the email address is associated with a second user;
creating a user account for the second user based on the email address, wherein the user account is used to access the web page;
receiving a phone number from the first user using the first mobile device, wherein the phone number is associated with the second user;
receiving a GPS location from the first user, wherein the GPS location is associated with the car;
receiving a resource from the first user, wherein the resource is associated with the GPS location of the car, and with which the second user will be used to access the car;
generating an access token, based on the phone number, the resource, the GPS location, and an encryption method;
generating an encrypted resource, based on the email address, phone number, the resource, the GPS location, and the encryption method;
sending an email message to the second user, wherein the email message includes instructions to access the encrypted resource by using the access token;
sending a text message, using the phone number, to the second user through the second mobile device to notify the second user that an email message relating to password management has been sent by the first user to the second user, wherein the text message includes the access token and the instructions to access the encrypted resource using the access token;
as an identification process, receiving the email address and the access token from the second user through the web page, wherein the identification process identifies the second user based on the email address and identifies the encrypted resource based on the access token and the GPS location;
decrypting the encrypted resource to retrieve the resource using the access token received from the second user, after successfully identifying the second user, the GPS location of the car, and the encrypted resource;
allowing the second user to access the car using the resource;
to allow the second user to share access of the encrypted resource, receiving an email address from the second user using the web page, wherein the email address is associated with a third user;
creating a user account for the third user based on the email address associated with the third user using the third mobile device, wherein the user account for the third user is used to access the web page;
receiving a phone number from the second user, wherein the phone number is associated with the third user;
generating an access token associated with the third user, based on the phone number associated with the third user, the encrypted resource, the GPS location, and encryption method;
sending an email message associated with the third user to the third user, wherein the email message associated with the third user includes instructions to access the encrypted resource using the access token associated with the third user;
sending a text message associated with the third user, using the phone number, to the third user to notify the third user that an email message relating to password management has been sent by the second user to the third user, wherein the text message associated with the third user includes the access token associated with the third user and the instructions to access the encrypted resource using the access token;
as an identification process, receiving the email address associated with the third user and the access token associated with the third user from the third user using the web page, wherein the identification process identifies the third user based on the email address associated with the third user and identifies the encrypted resource based on the access token associated with the third user, and the GPS location;
decrypting the encrypted resource to retrieve the resource using the access token received from the third user, after successfully identifying the third user, the GPS location of the car, and the encrypted resource; and
allowing the third user to access the car using the resource.

11. A secured video playback system for passing passwords between users, comprising:
a video player, wherein videos played by the player are password protected and being connecting to a network;
a video scanner to scan moving pictures shown by the video player;
a web page;
a processor;
a first mobile electronic device;
a second mobile electronic device;
a third mobile electronic device;
a memory storing instructions configured to be executed by the processor to implement a computer-implemented method, the method comprising:
receiving an email address from a first user using the first mobile electronic device, wherein the email address is associated with a second user;
creating a user account for the second user based on the email address, wherein the user account is used to access the web page;
receiving a phone number from the first user, wherein the phone number is associated with the second user;
receiving a resource from the first user, wherein the resource is associated with accessing a video stored in the video player;
generating an encrypted resource, based on the phone number, resource, and an encryption method;
generating a series of moving pictures, based on the email address, phone number, resource, and the encryption method;
sending an email message to the second user, wherein the email message includes instructions to access the encrypted resource using the series of moving pictures;
sending a text message to the second mobile electronic device, using the phone number, to the second user to notify the second user that an email message relating to password management has been sent by the first user to the second user, wherein the text message includes the series of moving pictures and the instructions to access the encrypted resource using the series of moving pictures;
as an identification process, receiving the email address and the series of moving pictures from the second user through the web page, wherein the identification process identifies the second user based on the email address, and the video scanner identifies the encrypted resource based on the series of moving pictures;
decrypting the encrypted resource to retrieve the resource after successfully identifying the second user, the series of moving pictures, and the encrypted resource;
allowing the second user to access the video using the decrypted resource;
to allow the second user to share access of the video, receiving an email address from the second user using the web page, wherein the email address is associated with a third user that is connected to the third mobile electronic device;
after receiving the email address from the second user, checking if the email address is found in a denied access list;
denying the third user from accessing the encrypted resource, after finding the email address associated with the third user in the denied access list; and
sending a second email message and a second text message to the second user to notify the denying of the third user from accessing the video.
